(19) United States
(12) Patent Application Publication
(10) Pub. No.: US 2023/0049119 A1
(43) Pub. Date: Feb. 16, 2023

(54) METHOD, APPARATUS AND TERMINAL FOR SKIPPING PAGING DETECTION, AND ACCESS NETWORK DEVICE

(71) Applicant: BEIJING XIAOMI MOBILE SOFTWARE CO., LTD., Beijing (CN)

(72) Inventor: Yang LIU, Beijing (CN)

(21) Appl. No.: 17/797,153

(22) PCT Filed: Feb. 13, 2020
(86) PCT No.: PCT/CN2020/075094

§ 371 Date: Aug. 3, 2022

(51) Int. Cl. H04W 68/02; H04W 52/02

(52) U.S. Cl. CPC H04W 68/02; H04W 52/0225

(57) ABSTRACT

A method for skipping paging detection is performed by a terminal, and includes: acquiring paging detection instruction information, the paging detection instruction information indicates to skip the paging detection of at least one paging opportunity period; and in response to the paging detection instruction information, skipping the paging detection of the at least one paging opportunity period.

### CROSS-REFERENCE

The present application is a U.S. National Stage of International Application No. PCT/CN2020/075094, filed on Feb. 13. 2020, the contents of which are incorporated herein by reference.

### TECHNICAL FIELD

The present disclosure relates to the field of communication technologies, and in particular, to a method and apparatus for skipping paging detection, a terminal, and an access network device.

### BACKGROUND

In an idle state, a terminal needs to perform paging detection according to a paging occasion period, which leads to power consumption of the terminal in the idle state.

### SUMMARY

Embodiments of the present disclosure provide a method and apparatus for skipping paging detection, a terminal, and an access network device.

According to an aspect of the embodiments of the present disclosure, there is provided a method for skipping paging detection, and the method includes:

acquiring paging detection indication information, wherein the paging detection indication information is used to indicate to skip paging detection of at least one paging occasion period; and

skipping the paging detection of the at least one paging occasion period in response to the paging detection indication information,

According to an aspect of the embodiments of the present disclosure, there is provided a method for skipping paging detection, and the method includes:

determining whether a terminal having a paging message is included in a group of terminals, wherein the paging message includes at least one of a short message and a paging scheduling message; and

sending paging detection indication information to the group of terminals in response to that all terminals in the group of terminals have no paging message, wherein the paging detection indication information is used to indicate to skip paging detection of at least one paging occasion period.

According to an aspect of the embodiments of the present disclosure, there is provided an apparatus for skipping paging detection, and the apparatus includes:

an acquiring module, configured to acquire paging detection indication information, wherein the paging detection indication information is used to indicate to skip paging detection of at least one paging occasion period; and

a control module, configured to skip the paging detection of the at least one paging occasion period in response to the paging detection indication information.

According to an aspect of the embodiments of the present disclosure, there is provided an apparatus for skipping paging detection, and the apparatus includes:

a determining module, configured to determine whether a terminal having a paging message is included in a group of terminals, wherein the paging message includes at least one of a short message and a paging scheduling message; and

a sending module, configured to send paging detection indication information to the group of terminals in response to that all terminals in the group of terminals have no paging message, wherein the paging detection indication information is used to indicate to skip paging detection of at least one paging occasion period.

According to another aspect of the embodiments of the present disclosure, there is provided a terminal, and the terminal includes: a processor; and a memory configured to store executable instructions by the processor; wherein the processor is configured to load and execute the executable instructions to implement the method for skipping the paging detection described above.

According to another aspect of the embodiments of the present disclosure, there is provided an access network device, and the access network device includes: a processor; and a memory configured to store executable instructions by the processor; wherein the processor is configured to load and execute the executable instructions to implement the method for skipping the paging detection described above.

According to another aspect of the embodiments of the present disclosure, there is provided a computer-readable storage medium, wherein instructions in the computer-readable storage medium, when executed by a processor, perform the method for skipping the paging detection described above.

it should be noted that the above general description and the following detailed description are merely exemplary and explanatory and should not be construed as limiting of the disclosure.

### BRIEF DESCRIPTION OF THE DRAWINGS

The accompanying drawings, which are incorporated in and constitute a part of the disclosure, illustrate embodiments consistent with the present disclosure and, together with the description, serve to explain the principle of the present disclosure.

FIG. 1 is a schematic diagram of a network architecture according to an embodiment of the present disclosure;

FIG. 2 is a flowchart showing a method for skipping paging detection according to an embodiment of the present disclosure;

FIG. 3 is a flowchart showing a method for skipping paging detection according to an embodiment of the present disclosure;

FIG. 4 is a flowchart showing a method for skipping paging detection according to an embodiment of the present disclosure;

FIG. 5 is a schematic structural diagram showing an apparatus for skipping paging detection according to an embodiment of the present disclosure;

FIG. 6 is a schematic structural diagram showing an apparatus for skipping paging detection according to an embodiment of the present disclosure;

FIG. 7 is a block diagram of a terminal according to an embodiment of the present disclosure; and

FIG. 8 is a block diagram of an access network device according to an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the present disclosure. Instead, they are merely examples of apparatuses and methods consistent with some aspects of the present disclosure as recited in the appended claims.

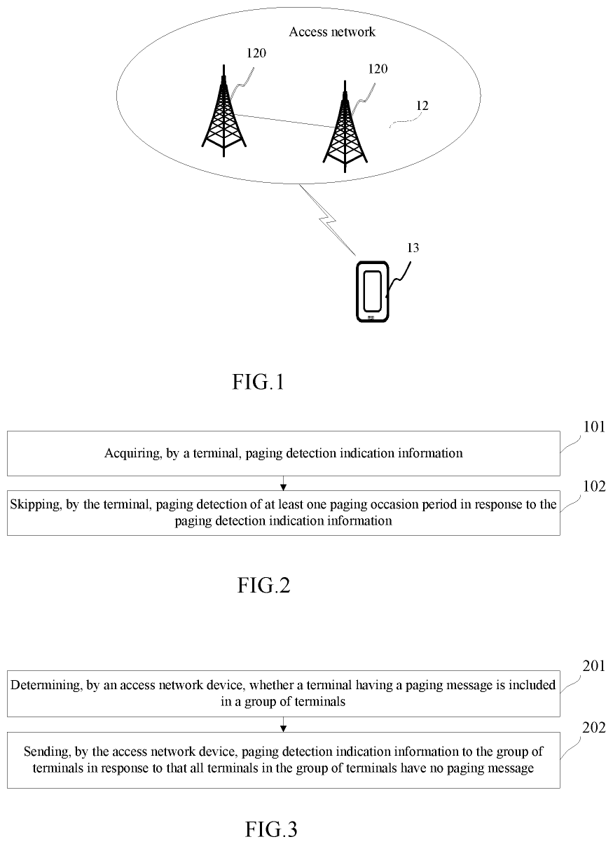

FIG. 1 shows a block diagram of a communication system provided by an embodiment of the present disclosure. As shown in FIG. 1, the communication system may include: an access network 12 and a terminal 13.

The access network 12 includes several access network devices 120. The access network device 120 may be a base station, and the base station refers to a device deployed in the access network to provide a wireless communication function for the terminal. The base station may include various forms of macro base stations, micro base stations, relay stations, access points and so on. In systems using different radio access technologies, devices with a base station function may have different names, and in the 5G New Radio (NR) system, a name of the device may be gNodeB or gNB. With the evolution of communication technologies, description of the name of the “base station” is changing. For ease of description, the above devices for providing the wireless communication function for the terminal are collectively referred to as “access network devices” in the following.

The terminal 13 may include various handheld devices, vehicle-mounted devices, wearable devices, computing devices with wireless communication functions or other processing devices connected to wireless modems, as well as various forms of user equipment (UEs), mobile stations (MSs), and terminal devices. For ease of description, the devices mentioned above are collectively referred to as “terminals”. The access network device 120 and the terminal 13 communicate with each other through a certain air interface technology, such as a Uu interface.

In an idle state, the terminal needs to perform paging detection according to a paging occasion period. The following is a brief description of how the terminal implements the paging detection.

The access network device configures several Paging Occasions (POs) and corresponding control channel resource information in one Synchronization Signal and Physical Broadcast Channel (PBCH) block (SSB) period.

According to a formula in R15 38.304, the terminal uses information such as its own identifier (ID) to calculate its own paging occasion position. When the paging occasion comes, the terminal detects Paging Downlink Control Information (Paging DCI) according to the configured control channel resource information.

The terminal acquires a paging category according to content of the DCI, and if it is a category scheduled by a paging message, a corresponding Physical Downlink Shared Channel (PDSCH) message (the resource is also indicated in the DCI) is demodulated.

After demodulating the PDSCH message, the terminal checks terminal IDs in the PDSCH message, and if there is no its own ID, it continues to wait for the next paging occasion, and then repeats the above processes.

However, the above-mentioned paging detection process needs to consume a larger amount of power, which increases power consumption of the terminal. For terminals defined by a research project of “Reduced capability NR devices” newly introduced in a R17 standard (hereinafter referred to as Redcap terminals for short), it is even more necessary to optimize the paging detection in a targeted manner to avoid excessive energy consumption caused by the paging detection.

The communication systems and service scenarios described in the embodiments of the present disclosure are for the purpose of illustrating the technical solutions of the embodiments of the present disclosure more clearly, and do not constitute a limitation on the technical solutions provided by the embodiments of the present disclosure. As understood by those of ordinary skill in the art, with the evolution of communication systems and the emergence of new service scenarios, the technical solutions provided by the embodiments of the present disclosure are also applicable to similar technical problems.

FIG. 2 is a flowchart showing a method for skipping paging detection according to an embodiment of the present disclosure. Referring to FIG. 2, the method includes the following steps 101 and 102.

In the step 101, a terminal acquires paging detection indication information.

The paging detection indication information is used to indicate to skip paging detection of at least one paging occasion period, and the paging detection indication information is sent by an access network device.

In the step 102, in response to the paging detection indication information, the terminal skips the paging detection of the at least one paging occasion period.

After receiving the paging detection indication information, the terminal skips the paging detection of the at least one paging occasion period according to the indication of the paging detection indication information, thereby saving power of the terminal and reducing power consumption.

In the embodiments of the present disclosure, the paging detection indication information is sent to the terminal by the access network device, so that the terminal can skip the paging detection of the at least one paging occasion period based on the paging detection indication information, thereby avoiding power waste caused by performing the paging detection for each paging occasion period, and saving the power of the terminal.

In some embodiments of the present disclosure, the acquiring the paging detection indication information may include:

receiving a DCI message sent by the access network device, and the DCI message carries the paging detection indication information.

In this implementation, the paging detection indication information is carried by the DCI message, and there is no need to define a new message, which facilitates the configuration of the access network device and the terminal. In addition, when the existing DCI message does not transmit a short message or a paging scheduling message, the remaining bits other than an indicator field are reserved, which can be used to carry the paging detection indication information.

In some embodiments of the present disclosure, the DCI message may include:

the indicator field for indicating that what is carried by the DCI message is the paging detection indication information; and

a paging detection indication information field for indicating the number of paging occasion periods for paging detection that need to he skipped.

In this implementation, the paging detection indication information field may indicate the number of paging occasion periods for paging detection that need to he skipped, so that the terminal can skip corresponding periods according to the number, thereby avoiding too many periods being skipped or too few periods being skipped, and avoiding missing normal paging to ensure normal communication while ensuring power saving.

In some embodiments of the present disclosure, before the skipping the paging detection of the at least one paging occasion period, the method may further include:

acquiring an identifier of a terminal skipping the paging detection; and

skipping the paging detection of the at least one paging occasion period if there is an identifier of the present terminal in the acquired identifier of the terminal skipping the paging detection.

In this implementation, the DCI in the original paging detection is used for the transmission of the paging detection indication information between the access network device and the terminal, and only content carried in the DCI message is different from content of the DCI in the original paging detection. In order to be consistent with an original paging detection process, an original step of acquiring the identifier of the terminal is still retained here, but the identifier of the terminal here no longer indicates a terminal with the paging, instead indicates a terminal skipping the paging detection. In this way, without changing a processing flow of the terminal and a message structure, the skipping of the paging detection is realized, which facilitates the design and configuration of the whole system. In addition, in this way, a terminal that skips the paging detection can also selected form a group of terminals in a targeted manner, which is ultimately more flexible to be realized.

In some embodiments of the present disclosure, the acquiring the identifier of the terminal skipping the paging detection may include:

receiving a PDSCH message sent by the access network device, and the PDSCH message carries the identifier of the terminal that skips the paging detection.

As mentioned above, in order to be consistent with a step in the existing process, the paging message may be used to carry the identifier of the terminal that skips the paging detection.

It should be noted that the steps 101-102 and the foregoing steps may he combined arbitrarily.

FIG. 3 is a flowchart showing a method for skipping paging detection according to an embodiment of the present disclosure. Referring to FIG. 3, the method includes the following steps 201 to 202.

In the step 201, an access network device determines whether a terminal having a paging message is included in a group of terminals, and the paging message includes at least one of a short message and a paging scheduling message.

The access network device stores a grouping condition of terminals. When receiving the paging message sent by a core network, the access network device can determine whether there is the terminal having the paging message in the group of terminals.

In the step 202, in response to that all terminals in the group of terminals have no paging message, the access network device sends paging detection indication information to the group of terminals, and the paging detection indication information is used to indicate to skip paging detection of at least one paging occasion period.

If there is the terminal having the paging message in the group of terminals, the paging detection indication information is not sent, and the terminal can perform the paging detection according to a conventional paging detection process.

In the embodiments of the present disclosure, the paging detection indication information is sent to the terminal by the access network device, so that the terminal can skip the paging detection of the at least one paging occasion period based on the paging detection indication information, thereby avoiding power waste caused by performing the paging detection for each paging occasion period, and saving the power of the terminal.

In some embodiments of the present disclosure, the sending the paging detection indication information to the group of terminals may include:

sending a DCI message to the group of terminals, and the DCI message carries the paging detection indication information.

In this implementation, the paging detection indication information is carried by the DCI message, and there is no need to define a new message, which facilitates the configuration of the access network device and the terminal. In addition, when the existing DCI message does not transmit the short message or the paging scheduling message, the remaining bits other than an indicator field are reserved, which can be used to carry the paging detection indication information.

In some embodiments of the present disclosure, the DCI message may include:

the indicator field for indicating that what is carried by the DCI message is the paging detection indication information; and

a paging detection indication information field for indicating the number of paging occasion periods for paging detection that need to be skipped.

In this implementation, the paging detection indication information field may indicate the number of paging occasion periods for paging detection that need to be skipped, so that the terminal can skip corresponding periods according to the number, thereby avoiding too many periods being skipped or too few periods being skipped, and avoiding missing normal paging to ensure normal communication while ensuring power saving.

In some embodiments of the present disclosure, the method may further include:

sending an identifier of a terminal skipping the paging detection to the group of terminals.

In this implementation, the terminal may determine whether to skip the paging detection according to the identifier of the terminal skipping the paging detection sent by the access network device. The DCI in the original paging detection is used for the transmission of the paging detection indication information between the access network device and the terminal, and only content carried in the DCI message is different from content of the DCI in the original paging detection. In order to be consistent with an original paging detection process, an original step of acquiring the identifier of the terminal is still retained here, but the identifier of the terminal here no longer indicates a terminal with the paging, instead indicates a terminal skipping the paging detection. In this way, without changing a processing flow of the terminal and a message structure, the skipping of the paging detection is realized, which facilitates the design and configuration of the whole system. In addition, in this way, a terminal that skips the paging detection can also selected form a group of terminals in a targeted manner, which is ultimately more flexible to be realized.

In some embodiments of the present disclosure, the sending the identifier of the terminal skipping the paging detection to the group of terminals may include:

sending a paging message to the group of terminals, and the paging message carries the identifier of the terminal skipping the paging detection.

As mentioned above, in order to be consistent with a step in the existing process, the paging message may be used to carry the identifier of the terminal that skips the paging detection.

In some embodiments of the present disclosure, the method may further include:

sending paging occasion configuration information to the terminal through a radio resource control message, and the paging occasion configuration information is used to indicate a paging occasion allocated to the terminal, paging occasions allocated to different types of terminals are different, and the types of the terminals are divided according to power saving requirements.

In this implementation, the access network device may divide the types of the terminals according to the power saving requirements, that is, different types in the present disclosure refer to different power saving requirements of the terminals. Different types of terminals are configured with different paging occasions, so as to realize the grouping of the terminals through the configured paging occasions.

In general, a terminal using a R15/16 standard and an Enhanced Mobile Broadband (eMBB) terminal using a R17 standard have a relatively low requirement for power saving, while the Redcap terminal using a R17 standard has a relatively high requirement for power saving. The solution for skipping the paging detection provided by the present disclosure is mainly applied to the above-mentioned Redcap terminal. Note that, this solution can also be compatible with the terminal using the R15/16 standard and the eMBB terminal using the R17 standard. The paging occasions are configured according to the above two types of terminals (with different power saving requirements), so that the above two types of terminals can be divided into different groups without changing a method for determining the paging occasion by the terminal.

Note that, the above-mentioned terminal classification is only an implementation. With the development of subsequent communication technologies and the change of characteristics of new terminal devices, the above-mentioned terminal types can be divided into more categories, thereby generating more terminal groups. For example, industrial sensors, video surveillance, wearable devices and the like in 5G do not need to support such a large bandwidth, and especially for the industrial sensors, they only require a transmission bandwidth of several megabytes. Such terminals may be classified as a new terminal type in a subsequent enhanced version of 5G. However, no matter how the terminal types are divided, the method provided by the present disclosure can be used to skip the paging detection, so as to achieve the purpose of saving power.

It should be noted that the steps 201-202 and the foregoing steps may be combined arbitrarily.

FIG. 4 is a flowchart showing a method for skipping paging detection according to an embodiment of the present disclosure. Referring to FIG. 4, the method includes the following steps 301 to 305.

In the step 301, an access network device determines whether a terminal having a paging message is included in a group of terminals, and the paging message includes at least one of a short message and a paging scheduling message. If the group of terminals has no paging message, the step 302 is executed otherwise, the access network device does not execute subsequent steps, and the terminal executes a paging detection step.

The paging scheduling message is used to indicate content such as frequency information, time information, a modulation and coding mode, a reference signal, and a subcarrier spacing of the paging.

The solution provided by the embodiments of the present disclosure is applicable to a situation where the terminal is in the idle state, that is, the access network device can determine whether there is the terminal having the paging message in the group of terminals when the group of terminals is in the idle state.

The access network device stores a grouping condition of terminals. When receiving the paging message sent by the core network, the access network device can determine whether there is the terminal having the paging message in individual groups of terminals.

In the embodiments of the present disclosure, for terminals accessing the same access network device, standards used by terminals grouped into one group are the same, for example, a group of terminals adopts the R17 standard, or a group of terminals adopts the R15/16 standard. In this way, for the terminals in the same group, the access network device can send messages in the same format, so that the solution provided by the present disclosure is not only applicable to the terminal using the R17 standard (hereinafter referred to as the R17 terminal for short), but also compatible with the terminal using the R15/16 standard (hereinafter referred to as the R15/16 terminal for short).

In the embodiments of the present disclosure, the access network device may allocate a paging occasion to the terminal according to a type of the terminal, and the type of the terminal is divided according to a power saving requirement.

In general, the R15/16 terminal and the R17 eMBB terminal have a relatively low requirement for power saving, while the R17 Redcap terminal has a relatively high requirement for power saving. The solution for skipping the paging detection provided by the present disclosure is mainly applied to the above-mentioned Redcap terminal. Note that, this solution for skipping the paging detection can also be compatible with the R15/16 terminal and the R17 eMBB terminal. The paging occasions are configured according to the above two types of terminals, so that the above two types of terminals can be divided into different groups without changing a method for determining the paging occasion by the terminal.

For example, the access network device determines four paging occasion positions, and allocates two paging occasion positions to the R15/16 terminal and the R17 eMBB terminal, and allocates the other two paging occasion positions to the R17 Redcap terminal. The access network device can send paging occasion configuration information to the terminal through a Radio Resource Control (RRC) message, and the paging occasion configuration information is used to indicate the paging occasion allocated to the terminal, paging occasions allocated to different types of terminals are different. For the R15/16 terminal and the R17 eMBB terminal, the RRC message carries paging occasion information allocated to the R15/16 terminal and the R17 eMBB terminal; and for the R17 Redcap terminal, the RRC message carries the paging occasion information allocated to the R15/16 terminal and the R17 eMBB terminal and paging occasion information (extended content) allocated to the R17 Redcap terminal, from which the R17 Redcap terminal can determine the paging occasion allocated to itself.

For the terminal, when a paging frame position and a paging occasion index are determined by a paging frame position formula and a paging occasion index formula, the R15/16 (R17 eMBB terminal) terminal and the R17 Redcap terminal can determine different paging occasions according to the paging occasion information. That is, even if the paging occasion index determined by the R15/16 terminal (R17 eMBB terminal) is the same as the paging occasion index determined by the R17 Redcap terminal, the paging occasion finally determined by the R15/16 terminal (R17 eMBB terminal) is different from the paging occasion finally determined by the R17 Redcap terminal due to different paging times allocated by the access network device.

The paging frame position (PF) formula is as follows:

PF=SFN mod T=(T div N)*(UE_ID mod N)

where SFN is a system frame number, that is, a frame number where the current terminal is located; T=min(Tc, Tue), Tc and Tue represent the paging occasion period set by the core network and a wireless side, respectively, Tue is read from a System Information Block 2 (SIB2), and Tc is obtained from a paging message of S1; N=min(T, nB), nB is read from the SIB2; and UE, ID is contained in the paging message of S1, and is calculated through an International Mobile Subscriber Identity (IMSI) modulo 1024.

The paging occasion index formula is as follows:

i_s=floor (UE_ID/N) mod Ns; Ns=max(1,nB/T).

A sub-frame number of the paging occasion, that is, the paging occasion index mentioned above, is determined by looking up a relationship table (which is pre-configured in the terminal) through the calculated Ns and i_s.

In the step 302, the access network device sends a DCI message to the group of terminals, and the DCI message carries paging detection indication information. The terminal receives the DCI message sent by the access network device.

In the embodiments of the present disclosure, the DCI message includes:

an indicator field for indicating that what is carried by the DCI message is the paging detection indication information; and

a paging detection indication information field for indicating the number of paging occasion periods for paging detection that need to be skipped.

Table 1 below shows a format of the DCI message when the DCI message carries the paging detection indication information, which is the same as a format of the existing DCI, and is not only applicable to the R17 standard, but also compatible with the R15/16 standard.

TABLE 1

| | |
|---|---|
| 00 | Reserved |

where 00 is the indicator field and is usually in the DCI, and the first two bits are indicators; in addition to 00 indicating that the following bits belong to the reserved field, 01 indicates that only scheduling information for paging is present in the DCI. 10 indicates that only the short message is present in the DCI, and 11 indicates that both the scheduling information for paging and the short message are present in the DCI.

In the embodiments of the present disclosure, the Reserved field typically occupies six bits, which can be used to carry the number of paging occasion periods for paging detection that need to be skipped. For example, the first four bits of the six bits can be used to indicate the number of paging occasion periods for paging detection that need to be skipped, which, for example, may be 4, 8, and so on.

In the embodiments of the present disclosure, the number of paging occasion periods for paging detection that need to be skipped may be determined by the access network device. That is, when the DCI message includes the paging detection indication information field, the method may further include: the access network device determines the number of paging occasion periods for paging detection that need to be skipped.

In the embodiments of the present disclosure, the determination of the number of paging occasion periods for paging detection that need to be skipped may be implemented in the following manner: the access network device predicts a paging arrival condition of a group of terminals according to a radio resource management algorithm and a scheduler condition, and then determines the number of paging occasion periods for paging detection that need to be skipped based on the prediction result, so as to achieve the effect of power saving.

Here, the access network device can predict the number of paging occasion periods for paging detection that can be skipped by each terminal in the group of terminals. Except a terminal by which the number of paging occasion periods can be skipped is zero, based on the number of paging occasion periods that can be skipped by the remaining terminals, the access network device selects the minimum number of paging occasion periods for paging detection that can be skipped or the average number of paging occasion periods for paging detection that can be skipped as the number of paging occasion periods for paging detection that need to be skipped carried in the DCI message.

In the step 303, the access network device sends a PDSCH message to the group of terminals, and the PDSCH message carries an identifier of a terminal skipping the paging detection. The terminal receives the PDSCH message sent by the access network device.

Here, the identifier of the terminal skipping the paging detection is an identifier of the terminal by which the number of periods that can be skipped determined by the access network device in the step 302 is not zero.

In this implementation, the terminal may determine whether to skip the paging detection according to the identifier of the terminal skipping the paging detection sent by the access network device. The DCI in the original paging detection is used for the transmission of the paging detection indication information between the access network device and the terminal, and only content carried in the DCI message is different from content of the DCI in the original paging detection. In order to be consistent with an original paging detection process, an original step of acquiring the identifier of the terminal is still retained here, but the identifier of the terminal here no longer indicates a terminal with the paging, instead indicates a terminal skipping the paging detection. In this way, without changing a processing flow of the terminal and a message structure, the skipping of the paging detection is realized, which facilitates the design and configuration of the whole system. In addition, in this way, a terminal that skips the paging detection can also selected form a group of terminals in a targeted manner, which is ultimately more flexible to be realized.

In the step 304, the terminal determines whether its own identifier is included in the identifier of the terminal skipping the paging detection, and when there is its own identifier in the identifier of the terminal skipping the paging detection, the step 305 is executed, when there is no its own identifier in the identifier of the terminal skipping the paging detection, the paging detection step is executed.

As mentioned above, when the terminal needs to perform the paging detection, for the R15/16 terminal (R17 eMBB terminal) and the R17 Redcap terminal, even if the calculated the paging occasion indexes are the same, the finally determined paging times are different.

In the step 305, the terminal skips the paging detection of the at least one paging occasion period.

In this implementation, the terminal can determine the number of paging occasion periods for paging detection that need to be skipped based on the paging detection indication information field in the DCI message, and then skip the paging detection that needs to be performed originally according to the number.

If there is the paging sent to the terminal within the at least one paging occasion period, the access network device will wait until the paging occasion period to he skipped has elapsed before processing the paging of the terminal. For example, if the terminal needs to skip n (a positive integer) paging occasion periods, and the paging of this terminal is arrived before the nth paging occasion period, a processing manner of the access network device is to wait until the n+1th paging occasion period before forwarding the paging, to the terminal.

FIG, 5 is a schematic structural diagram showing an apparatus for skipping paging detection according to an embodiment of the present disclosure. The apparatus has a function realizing the terminal in the above method embodiments, and the function may be realized by hardware, or by the hardware executing corresponding software. As shown in FIG. 5, the apparatus includes: an acquiring module 401 and a control module 402.

The acquiring module 401 is configured to acquire paging detection indication information, and the paging detection indication information is used to indicate to skip paging detection of at least one paging occasion period; and

the control module 402 is configured to skip the paging detection of the at least one paging occasion period in response to the paging detection indication information.

In some embodiments of the present disclosure, the acquiring module 401 is configured to receive a DCI message sent by an access network device, and the DCI message carries the paging detection indication information.

In some embodiments of the present disclosure, the DCI message includes:

an indicator field for indicating that what is carried by the DCI message is the paging detection indication information; and

a paging detection indication information field for indicating the number of paging occasion periods for paging detection that need to be skipped.

In some embodiments of the present disclosure, the acquiring module 401 is further configured to acquire an identifier of a terminal skipping the paging detection; and

the control module 402 is configured to skip the paging detection of the at least one paging occasion period if an identifier of the present terminal is included in the acquired identifier of the terminal skipping the paging detection.

In an implementation of the present disclosure, the acquiring module 401 is configured to receive a PDSCH message sent by the access network device, and the PDSCH message carries the identifier of the terminal that skips the paging detection.

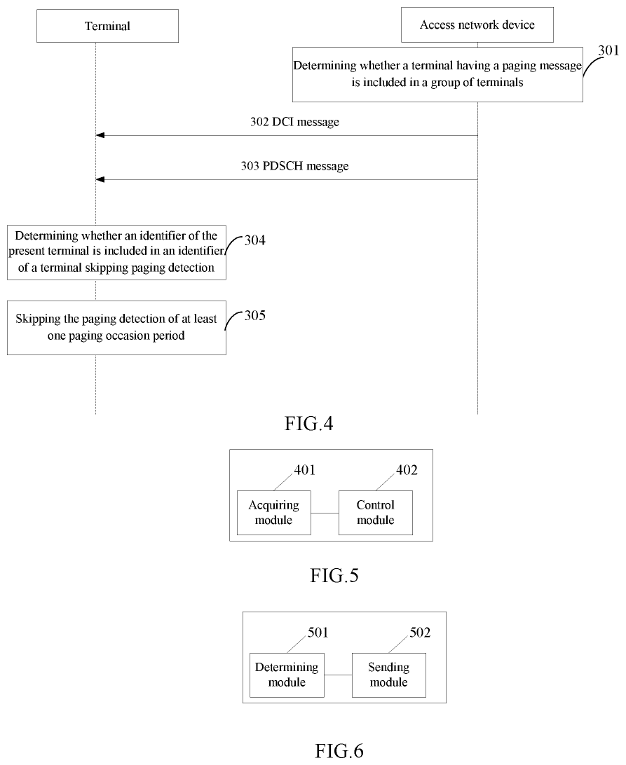

FIG. 6 is a schematic structural diagram showing an apparatus for skipping paging detection according to an embodiment of the present disclosure. The apparatus has a function realizing the access network device in the above method embodiments, and the function may be realized by hardware, or by the hardware executing corresponding software. As shown in FIG. 6, the apparatus includes: a determining module 501 and a sending module 502.

The determining module 501 is configured to determine whether a terminal having a paging message is included in a group of terminals, and the paging message includes at least one of a short message and a paging scheduling message; and

the sending module 502 is configured to send paging detection indication information to the group of terminals in response to that all terminals in the group of terminals have no paging message, and the paging detection indication information is used to indicate to skip paging detection of at least one paging occasion period.

In some embodiments of the present disclosure, the sending module 502 is configured to send a DCI message to the group of terminals, and the DCI message carries the paging detection indication information.

In some embodiments of the present disclosure, the DCI message includes:

an indicator field for indicating that what is carried by the downlink control information message is the paging detection indication information; and

a paging detection indication information field for indicating the number of paging occasion periods for paging detection that need to be skipped.

In some embodiments of the present disclosure, the sending module 502 is further configured to send an identifier of a terminal skipping the paging detection to the group of terminals.

In some embodiments of the present disclosure, the sending module 502 is configured to send a paging message to the group of terminals, and the paging message carries the identifier of the terminal that skips the paging detection.

In the embodiments of the present disclosure, the sending module 502 is further configured to send paging occasion configuration information to a terminal through a radio resource control message, and the paging occasion configuration information is used to indicate a paging occasion allocated to the terminal, paging occasions allocated to different types of terminals are different, and the types of the terminals are divided according to power saving requirements.

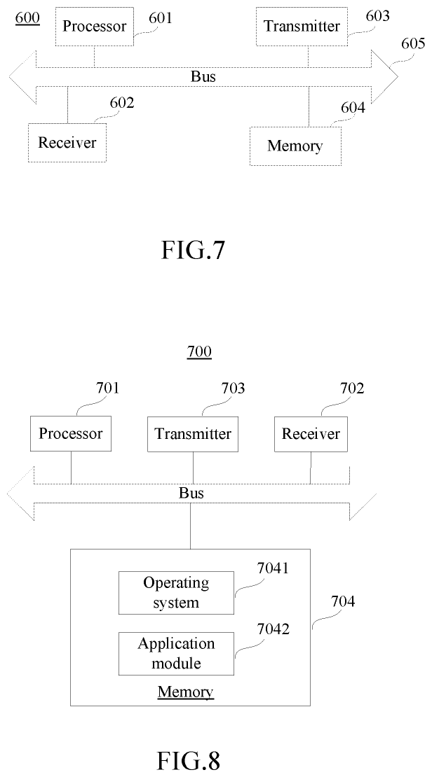

FIG. 7 is a block diagram showing a terminal 600 according to an embodiment of the present disclosure. The terminal 600 includes: a processor 601, a receiver 602, a transmitter 603, a memory 604 and a bus 605.

The processor 601 includes one or more processing cores, and the processor 601 executes various functional applications and information processing by running software programs and modules.

The receiver 602 and the transmitter 603 may be implemented as a communication component, and the communication component may be a communication chip.

The memory 604 is connected to the processor 601 through the bus 605.

The memory 604 may be used to store at least one instruction, and the processor 601 is configured to execute the at least one instruction to implement each step in the above method embodiments.

In addition, the memory 604 may be implemented using any type of volatile or non-volatile memory devices, or a combination thereof. The volatile or non-volatile memory devices include but not limited to: a magnetic or optical disk, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

In the embodiments of the present disclosure, there is further provided a computer-readable storage medium in which at least one instruction, at least one segment of program, a code set, or an instruction set is stored, the at least one instruction, the at least one segment of program, the code set or the instruction set is loaded and executed by a processor to implement the method for skipping the paging detection provided by the above various method embodiments.

FIG. 8 is a block diagram showing an access network device 700 according to an embodiment of the present disclosure. The access network device 700 may include: a processor 701, a receiver 702, a transmitter 703, and a memory 704. The receiver 702, the transmitter 703, and the memory 704 are respectively connected to the processor 701 through a bus.

The processor 701 includes one or more processing cores, and the processor 701 executes the method executed by the access network device in the method for skipping the paging detection provided by the embodiments of the present disclosure by running software programs and modules. The memory 704 can be configured to store the software programs and modules. In detail, the memory 704 may store an operating system 7041 and an application module 7042 required by at least one function. The receiver 702 is configured to receive communication data sent by other devices, and the transmitter 703 is configured to send the communication data to other devices.

In the embodiments of the present disclosure, there is further provided a computer-readable storage medium in which at least one instruction, at least one segment of program, a code set, or an instruction set is stored, the at least one instruction, the at least one segment of program, the code set or the instruction set is loaded and executed by a processor to implement the method for skipping the paging detection provided by the above various method embodiments.

The embodiments of the present disclosure further provide a system for skipping paging detection, and the system for skipping the paging detection includes a terminal and an access network device. The terminal is the terminal provided by the embodiment shown in FIG. 7, and the access network device is the access network device provided by the embodiment shown in FIG. 8.

The embodiments of the present disclosure provide a method and apparatus for skipping paging detection, a terminal, and an access network device.

According to an aspect of the embodiments of the present disclosure, there is provided a method for skipping paging detection, and the method includes:

acquiring paging detection indication information, wherein the paging detection indication information is used to indicate to skip paging detection of at least one paging occasion period; and

skipping the paging detection of the at least one paging occasion period in response to the paging detection indication information.

In an implementation of the present disclosure, the acquiring the paging detection indication information includes:

receiving a downlink control information message sent by an access network device, wherein the paging detection indication information is carried by the downlink control information message.

In an implementation of the present disclosure, the downlink control information message includes:

an indicator field for indicating that what is carded by the downlink control information message is the paging detection indication information; and

a paging detection indication information field for indicating the number of paging occasion periods for paging detection that need to be skipped.

In an implementation of the present disclosure, before the skipping the paging detection of the at least one paging occasion period, the method further includes:

acquiring an identifier of a terminal skipping the paging detection; and

skipping the paging detection of the at least one paging occasion period if an identifier of the present terminal is included in the acquired identifier of the terminal skipping the paging detection.

In an implementation of the present disclosure, the acquiring the identifier of the terminal skipping the paging detection includes:

receiving a physical downlink shared channel message sent by the access network device, wherein the identifier of the terminal skipping the paging detection is carried by the physical downlink shared channel message.

According to an aspect of the embodiments of the present disclosure, there is provided a method for skipping paging detection, and the method includes:

determining whether a terminal having a paging message is included in a group of terminals, wherein the paging message includes at least one of a short message and a paging scheduling message; and

sending paging detection indication information to the group of terminals in response to that all terminals in the group of terminals have no paging message, wherein the paging detection indication information is used to indicate to skip paging detection of at least one paging occasion period.

In an implementation of the present disclosure, the sending the paging detection indication information to the group of terminals includes:

sending a downlink control information message to the group of terminals, wherein the paging detection indication information is carried by the downlink control information message.

In an implementation of the present disclosure, the downlink control information message includes:

an indicator field for indicating that what is carried by the downlink control information message is the paging detection indication information; and

a paging detection indication information field for indicating the number of paging occasion periods for paging detection that need to he skipped.

In an implementation of the present disclosure, the method further includes:

sending an identifier of a terminal skipping the paging detection to the group of terminals.

In an implementation of the present disclosure, the sending the identifier of the terminal skipping the paging detection to the group of terminals includes:

sending the paging message to the group of terminals, wherein the identifier of the terminal skipping the paging detection is carried by the paging message.

In an implementation of the present disclosure, the method further includes:

sending paging occasion configuration information to the terminal through a radio resource control message, wherein the paging occasion configuration information is used to indicate a paging occasion allocated to the terminal, and wherein different paging occasions are allocated to different types of terminals, and the types of the terminals are divided according to power saving requirements.

According to an aspect of the embodiments of the present disclosure, there is provided an apparatus for skipping paging detection, and the apparatus includes:

an acquiring module, configured to acquire paging detection indication information, wherein the paging detection indication information is used to indicate to skip paging detection of at least one paging occasion period; and

a control module, configured to skip the paging detection of the at least one paging occasion period in response to the paging detection indication information.

According to an aspect of the embodiments of the present disclosure, there is provided an apparatus for skipping paging detection, and the apparatus includes:

a determining module, configured to determine whether a terminal having a paging message is included in a group of terminals, wherein the paging message includes at least one of a short message and a paging scheduling message; and

a sending module, configured to send paging detection indication information to the group of terminals in response to that all terminals in the group of terminals have no paging message, wherein the paging detection indication information is used to indicate to skip paging detection of at least one paging occasion period.

According to another aspect of the embodiments of the present disclosure, there is provided a terminal, and the terminal includes: a processor; and a memory configured to store executable instructions by the processor; wherein the processor is configured to load and execute the executable instructions to implement the method for skipping the paging detection described above.

According to another aspect of the embodiments of the present disclosure, there is provided an access network device, and the access network device includes: a processor; and a memory configured to store executable instructions by the processor; wherein the processor is configured to load and execute the executable instructions to implement the method for skipping the paging detection described above.

According to another aspect of the embodiments of the present disclosure, there is provided a computer-readable storage medium, wherein instructions in the computer-readable storage medium, when executed by a processor, perform the method for skipping the paging detection described above.

Other embodiments of the present disclosure will be apparent to those skilled in the art from consideration of the specification and practice of the present disclosure disclosed herein. The present application is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

It should be understood that the present disclosure is not limited to the precise structures that have been described above and shown in the drawings, and various modifications and changes can he made without departing from the scope thereof. The scope of the present disclosure is limited only by the appended claims.

1. A method for skipping paging detection, performed by a terminal, and comprising:
acquiring paging detection indication information, wherein the paging detection indication information indicates to skip paging detection of at least one paging occasion period; and
skipping the paging detection of the at least one paging occasion period in response to the paging detection indication information.

2. The method according to claim 1, wherein the acquiring the paging detection indication information comprises:
receiving a downlink control information message sent by an access network device, wherein the paging detection indication information is carried by the downlink control information message.

3. The method according to claim 2, wherein the downlink control information message comprises:
an indicator field for indicating that what is carried by the downlink control information message is the paging detection indication information; and
a paging detection indication information field for indicating a number of paging occasion periods for paging detection that need to be skipped.

4. The method according to claim 2, wherein before the skipping the paging detection of the at least one paging occasion period, the method further comprises:
acquiring an identifier of a skipping-paging-detection terminal; and
skipping the paging detection of the at least one paging occasion period if an identifier of the terminal is comprised in the acquired identifier of the skipping-paging-detection terminal.

5. The method according to claim 4, wherein the acquiring the identifier of the skipping-paging-detection terminal comprises:
receiving a physical downlink shared channel message sent by the access network device, wherein the identifier of the skipping-paging-detection terminal is carried by the physical downlink shared channel message.

6. A method for skipping paging detection, performed by an access network device, and comprising:
determining whether a terminal having a paging message is comprised in a group of terminals, wherein the paging message comprises at least one of a short message and a paging scheduling message; and
sending paging detection indication information to the group of terminals in response to that all terminals in the group of terminals have no paging message, wherein the paging detection indication information indicates to skip paging detection of at least one paging occasion period.

7. The method according to claim 6, wherein the sending the paging detection indication information to the group of terminals comprises:
sending a downlink control information message to the group of terminals, wherein the paging detection indication information is carried by the downlink control information message.

8. The method according to claim 7, wherein the downlink control information message comprises:
an indicator field for indicating that what is carried by the downlink control information message is the paging detection indication information; and
a paging detection indication information field for indicating the number of paging occasion periods for paging detection that need to be skipped.

9. The method according to claim 7, further comprising:
sending an identifier of a skipping-paging-detection terminal to the group of terminals.

10. The method according to claim 9, wherein the sending the identifier of the skipping-paging-detection terminal to the group of terminals comprises:
sending a physical downlink shared channel message to the group of terminals, wherein the identifier of the skipping-paging-detection terminal is carried by the physical downlink shared channel message.

11. The method according to claim 6, further comprising:
sending paging occasion configuration information to a terminal through a radio resource control message, wherein the paging occasion configuration information indicates a paging occasion allocated to the terminal, and wherein paging occasions allocated to different types of terminals are different, and the types of the terminals are divided according to power saving requirements.

12. (canceled)

13. (canceled)

14. A terminal, comprising:
a processor; and
a memory configured to store executable instructions by the processor;
wherein the processor is configured to:
acquire paging detection indication information, wherein the paging detection indication information indicates to skip paging detection of at least one paging occasion period; and
skip the paging detection of the at least one paging occasion period in response to the paging detection indication information.

15. An access network device, comprising;
a processor; and
a memory configured to store executable instructions by the processor;
wherein the processor is configured to perform the method according to claim 6.

16. A non-transitory computer-readable storage medium having stored therein instructions that, when executed by a processor, cause the processor to perform the method according to claim 1.

17. A non-transitory computer-readable storage medium having stored therein instructions that, when executed by a processor, cause the processor to perform the method according to claim 6.

18. The terminal according to claim 14, wherein in acquiring the paging detection indication information, the processor is further configured to:
receive a downlink control information message sent by an access network device, wherein the paging detection indication information is carried by the downlink control information message.

19. The terminal according to claim 18, wherein the downlink control information message comprises:
an indicator field for indicating that what is carried by the downlink control information message is the paging detection indication information; and
a paging detection indication information field for indicating a number of paging occasion periods for paging detection that need to be skipped.

20. The terminal according to claim 18, wherein before the skipping the paging detection of the at least one paging occasion period, the processor is further configured to:
acquire an identifier of a skipping-paging-detection terminal; and
skip the paging detection of the at least one paging occasion period if an identifier of the terminal is comprised in the acquired identifier of the skipping-paging-detection terminal.
